(19) United States
(12) Patent Application Publication
(10) Pub. No.: US 2003/0110104 A1
(43) Pub. Date: Jun. 12, 2003

(54) Enhanced vendor managed inventory system and process

(75) Inventors: Steven King, Torrence, CA (US); Ed Collins, Redondo Beach, CA (US); Lloyd Kaplan, Manhattan Beach, CA (US); Brian Mankinen, Hermosa Beach, CA (US); Rod Herring, Hermosa Beach, CA (US)

Correspondence Address: OSTROLENK FABER GERB & SOFFEN, 1180 AVENUE OF THE AMERICAS, NEW YORK, NY, 100368403

(73) Assignee: iSuppli Corp.

(21) Appl. No.: 10/277,490

(22) Filed: Oct. 21, 2002

Related U.S. Application Data
(60) Provisional application No. 60/384,173, filed on May 29, 2002.
(60) Provisional application No. 60/354,813, filed on Feb. 6, 2002.
(60) Provisional application No. 60/330,499, filed on Oct. 23, 2001.
(60) Provisional application No. 60/333,483, filed on Nov. 28, 2001.

(51) Int. Cl. G06F 17/60

(52) U.S. Cl. 705/28

(57) ABSTRACT

The invention is directed to inventory management associated with providing components and materials (“components”) to customers, with particular regard to monitoring and managing value-added services, for example programming, assembly and aggregating services that are performed on the components, and further to disseminating information directed to inventory management. The present invention effectively reduces the required number of inventory storage locations compared to prior inventory management systems. Additionally, information sharing directed to customer demands, inventory levels, advance shipping notices, work in process, and delivery and replenishment is improved by processes of the present invention. Moreover, the invention provides direct replenishment of inventory after components are delivered to customers.

### CROSS-REFERENCE TO RELATED APPLICATIONS

This application is based upon and claims priority to U.S. provisional patent application Serial No. 60/384,173 filed May 29, 2002 and entitled VENDOR MANAGED INVENTORY PROCESS, U.S. provisional patent application Serial No. 60/354,813 filed on Feb. 6, 2002 and entitled VENDOR MANAGED INVENTORY PROCESS, U.S. provisional patent application Serial No. 60/330,499 filed on Oct. 23, 2001 and entitled VENDOR MANAGED INVENTORY PROCESS, U.S. patent application Ser. No. 09/758,509 filed Jan. 11, 2001 and entitled SUPPLY CHAIN ARCHITECTURE, and U.S. provisional patent application Serial No. 60/333,483 filed Nov. 28, 2001 and entitled SUPPLY CHAIN NETWORK, the entire contents of all of which are hereby incorporated by reference.

### FIELD OF THE INVENTION

The present invention relates to processes for managing the supply of inventory, and more particularly to receiving forecasted demands from customers that are directed to inventory needs, managing, fulfilling the inventory demands, and replenishing the supply of inventory.

### BACKGROUND OF THE INVENTION

Manufacturers require components and materials (generally referred to herein as “components”) to produce their goods. Frequently, manufacturers require services to be performed on the components they require. For example, programming services may be necessary in order for electronic components to conform to particular demand. As used herein, the term, “value-added components,” refers to components that are serviced by a specialist to incorporate one or more new features. Suppliers provide components and value-added components to manufacturers through supply chains.

Referring to the drawing figures in which like reference designators refer to like elements, there is shown in FIG. 1 an example prior art supply chain arrangement. As shown in FIG. 1, a customer 2, for example a manufacturer, receives components from a supplier 4. The supplier 4 interacts with value-added service provider 6 to provide value-added services on the components for the customer 2. The supplier 4 maintains a location in close proximity to a customer, referred to herein generally as a “proximity hub 8,” for storing an inventory of components for sale. Inventory is typically transferred between suppliers 4, proximity hubs 8 and customers 2 via carrier 7 and distributor 9.

In general, a supply chain involves any and all activities associated with defining, designing, producing, receiving, monitoring, storing, and using components and services required for manufacturing a product. In prior art supply chains, manufacturers inaccurately forecast needs. Inaccurate forecasted demands result in slow moving inventories, shortages in times of need, and a lack of resources required to manage the supply chain properly. Manufacturers are faced with high costs associated with inefficient supply chain management.

A significant portion of supply chain management costs are attributed to inventory procurement and management. Inventory management includes planning, purchasing, receiving in-bound freight, infrastructure management and transportation, and accounting. Costs associated with inventory management in a supply chain can account for between 5%-25% of corporate expenditures. A 20% reduction in supply chain cost significantly improves and, in many cases, can as much as double profits for any given customer 2.

In prior art supply chains, suppliers 4 maintain inventory in proximity hubs 8 to accommodate weeks of customer demands for inventory. By maintaining large amounts of inventory, suppliers 4 are able to provide inventory to customers 2 quickly. However, maintaining large amounts of inventory in proximity hubs 8 is expensive and inefficient.

Another cause for inefficient prior art supply chain operations is the employment of a plurality of proximity hubs 8 by suppliers 4. Costs are frequently disproportionately high because inventory and proximity hub 8 infrastructure maintenance are often duplicated over different regions. Additionally, in prior art supply chains, the period of time between receiving a request for value-added components and delivery thereof (i.e., “cycle times”) is long, and prohibitively expensive for value-added components, often 16%-20% of component values. These excessive costs also contribute to inefficiencies in prior art supply chain systems.

Information directed inventory management, including retrieving components from a proximity hub 8, placing components in transit and performing value-added services is not made centrally available to customers 2 and suppliers 4. A lack of information distribution also contributes to an inefficient and expensive supply chain. Moreover, as the number of participants increases, the system grows more complex and inefficient.

Traditional supply chain models employ distributors and third party logistics operators. Typically, distributors purchase inventory based on speculation and their opinion of inventory levels required to support customers. They increase the price of the inventory, and resell it to customers, for example, electronic manufacturers (“EMS”). Since distributors are typically focused on profit, they tend to obscure information received from participants in a supply chain in order to protect those profits. Moreover, distributors require suppliers to use programs, such as stock rotation programs and ship-and-debit programs, that force suppliers to purchase a portion of any inventory that has not sold within a predetermined period of time. This increases suppliers' inventory risk by leaving them liable for inventory that has been out of their visibility, control, and planning purview.

Third-party logistics providers have limitations that yield similar liability and inventory risk issues for suppliers. Third party providers merely execute instructions from suppliers without any additional forecast analysis or inventory data analysis being performed. Inventory is stored in third-party logistics providers' warehouses, frequently resulting in over-stocking or under-stocking inventory that leads to increased liability from the excess inventory levels or stock-outs.

### SUMMARY OF THE INVENTION

The present invention addresses and solves many of the inefficiencies associated with prior art supply chains described above.

The invention is directed to inventory management associated with providing components to customers, with particular regard to managing and monitoring operations associated with supplying components to customers in a supply chain.

The processes associated with the present invention are directed to inventory planning, order fulfillment and inventory replenishment. During the planning process, customer forecasts are received, validated, and analyzed with respect to historic forecasted demands, inventory positions, historic consumption data, in-transit and work-in-process data. At least one of a demand and order management provider and a supply chain server performs such analysis in order to generate a customer demand plan and a value-added programming demand plan. Moreover, a replenishment plan is similarly developed from at least one of inventory levels, desired safety stock levels, in-transit inventory levels, and work-in-process levels. A supplier shipment schedule is also developed by the demand and order management provider, and is transmitted to a supplier who sends a supply commitment in response thereto. A supply and demand match is, thereafter, performed by the demand and order management provider, and a supply plan is generated and transmitted to the customer.

During the order and fulfillment process, demand pulls are received and validated by the demand and order management provider. The demand and order management provider confirms the presence of available inventory, and generates shipment and value-added service instructions. Components are retrieved by a global logistics provider, and services are performed by the value-added service provider. The global service provider receives the value-added components and builds customer shipments, generates advance shipping information and ships the orders to customers. The demand and order management provider receives shipment confirmation, supplements it with additional information required by the supplier in order to complete the booking, shipping and billing processes for an order, and then transmits a shipment advice to the supplier who uses the advice to invoice customers.

A component of the replenishment process that is executed on a periodic basis (e.g., monthly or quarterly, in part depending on agreements between the supplier and the demand and order management provider) is the analysis, evaluation, and recommendation of inventory target levels. Target levels can be kept, or increased or decreased based upon results of the analysis. The demand and order management provider validates and/or adjusts inventory target levels, and receives approval of the target inventory levels from the supplier. The demand and order management provider generates a replenishment demand plan (usually an inter-company transfer), and transmits the replenishment demand plan to the supplier. The supplier prepares advance shipping notice, tenders the components and performs inter-site accounting. The global logistics provider receives the advance shipping notice, and also receives the components and stores them in the inventory storage location.

During the replenishment process, the demand and order management provider receives inventory updates, and uses the updates for validating future demand pulls. In addition to generating a replenishment order, the demand and order management provider generates programming orders for the value-added service provider. In such case, the global logistics provider retrieves components from the inventory storage location, and transfers the components to the value-added service provider. The value-added service provider performs services on the components, and, thereafter, transmits the value-added components to the global logistics provider. The global logistics provider receives the value-added components and stores them in the inventory storage location.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention which refers to the accompanying drawings, in which:

FIG. 1 is a diagram of a prior art supply chain with respect to managing inventory;

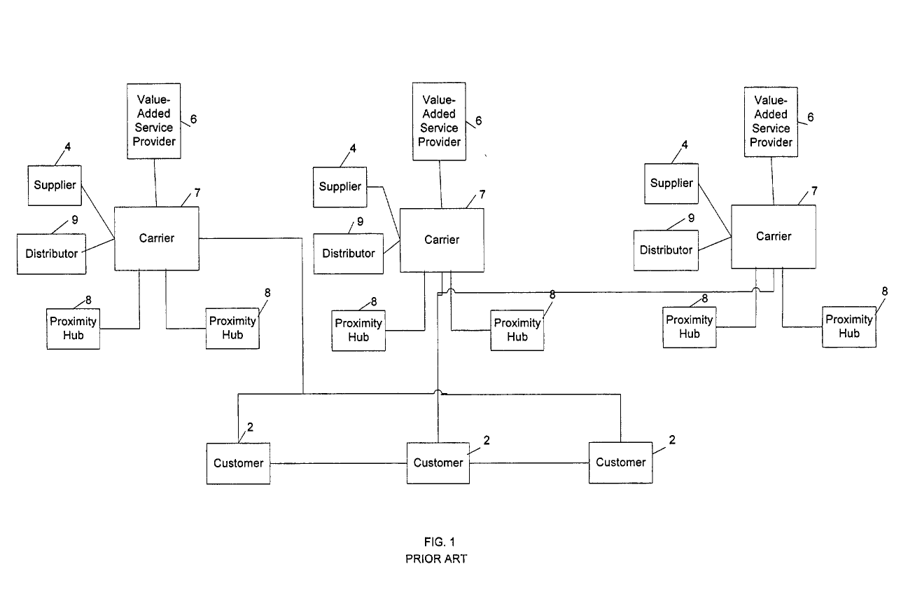

FIG. 2 shows the interaction between a partnership of service providers, and customers and suppliers in accordance with the present invention;

FIG. 3 shows an example arrangement of parties associated with implementing VMI processes in accordance with the present invention;

FIG. 4 identifies elements created by demand and order management providers and global logistics providers in accordance with the present invention;

FIG. 5 shows elements created by a supply chain server, global logistics provider and supplier in accordance with the present invention;

FIG. 6 shows an interaction between a demand and order management provider, supply chain server, global logistics provider and value added service provider during an order and planning process, fulfillment process and replenishment process in accordance with the present invention;

FIG. 7 is a flowchart illustrating the steps associated with planning according to a first preferred embodiment of the present invention;

FIG. 8 depicts a flowchart illustrating the steps associated with ordering and fulfillment in accordance with a first preferred embodiment of the present invention;

FIG. 9 shows a flowchart defining the steps associated with processes for replenishing vendor managed inventory in accordance with a first preferred embodiment of the present invention;

FIG. 10 is a flowchart showing the steps associated with forecasting and planning processes in accordance with a second preferred embodiment of the present invention;

FIG. 11 illustrates a flowchart showing the steps associated with order management and fulfillment processes in accordance with a second preferred embodiment of the present invention; and

FIG. 12 depicts a flowchart illustrating the steps associated with replenishing inventory in accordance with a second preferred embodiment of the present invention.

### DETAILED DESCRIPTION OF EMBODIMENTS OF THE INVENTION

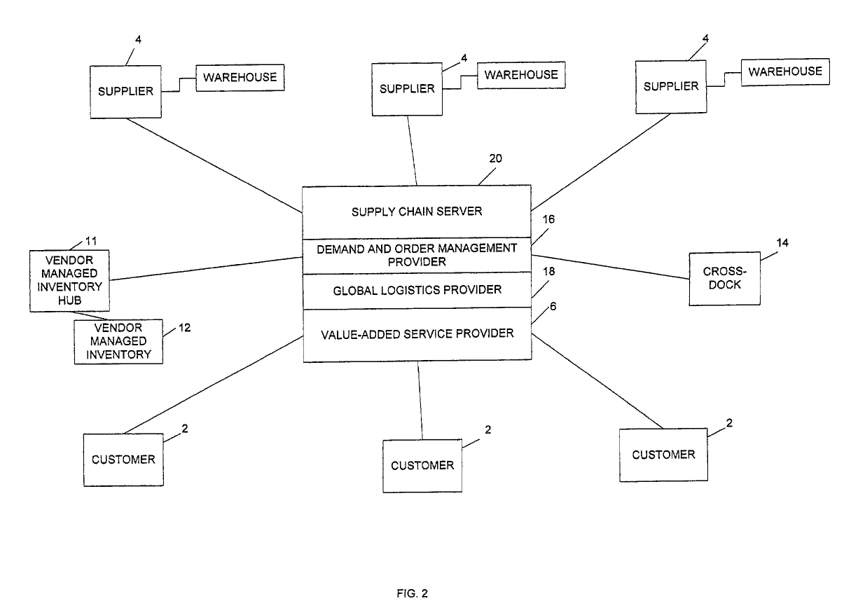

FIG. 2 shows an inventory management system in accordance with the present invention and designated generally as “VMI inventory system 10.” VMI inventory system 10 reduces complexity and improves management associated with prior art supply chains with respect to inventory management.

As shown in FIG. 2, a small number of regional VMI hubs 11 replace voluminous prior art proximity hubs, and are capable of receiving inventory from a company warehouse within a short period of time, for example, forty-eight hours. By reducing the number of VMI hubs 11 storing inventory, referred to herein as “VMI inventory 12,” the total amount of VMI inventory 12 required to be stored for customers 2 is significantly reduced. A reduction in VMI inventory 12 can result in a reduction in supply chain costs by 30%-60%. Moreover, same and next day availability is available for exception handling. By employing the features described herein, the present invention dramatically improves inventory visibility, tracking and management throughout the supply chain, and results in significant cost savings.

In order to reduce the likelihood of suppliers 4 facing inventory shortages, in accordance with the present invention, direct replenishment is employed that effectively reduces and prevents inventory shortages. In such case customer orders bypass a VMI hub 11, and inventory is shipped directly from the supplier to the customer using direct replenishment, a twenty-four hour delivery period is available during which order processing is performed.

Many customer demands received in a supply chain include a significant amount of pre-assembly kit assembly and configuration, as well as physical and demand aggregation. These value-added services can be performed at a logistics provider's location, referred to herein generally as “cross-dock 14” (FIG. 2). Cross-docks 14 are typically located at the same site as the regional VMI hub 11 wherein value-added service providers 6 provide services including programming, tape and reel, part marking, and testing of products and services at cross-docks 14. Moreover, inventory aggregation is typically performed at cross docks 14.

As shown in FIG. 2, a demand and order management provider 16, a global logistics provider 18, a supply chain server 20 and a value-added service provider 6 participate as the supply chain server 20 and/or the demand and order management provider 16 directs them in order to manage VMI inventory 12 in accordance with the processes of the present invention.

As used herein, the demand and order management order provider 16 and supply chain server 20 refer to a real party in interest who is responsible for performing the duties thereof and as described herein. For example, the supply chain server 20 need not be implemented as a computer since, as used herein, the operator of the supply chain server is the real party in interest. Also as used herein, the demand and order management provider 16 and the supply chain server 20 may be the same entity, or, alternatively, are separate entities.

Furthermore, and as used herein, VMI inventory 12 that is being transported to a value-added service provider 6, customer 2 or other party in the supply chain is generally referred to as “in-transit.” VMI inventory 12 that is being modified or supported with one or more value-added services is generally referred to herein as work in process inventory, or “WIP.”

Also as used herein, a “parent part number” refers to an identifier of a component that is furnished by a supplier 4 and that has had no value-added services, for example, programming and assembly tasks, performed thereon. The term, “child part number,” refers to an identifier of a component that has had value-added services performed thereon. In accordance with the present invention, customers 2 preferably submit forecasted demands using child part numbers, and suppliers 4 submit information directed to components using parent part numbers. The demand and order management provider 16 or supply chain server 20 preferably performs conversion processes on information received by one respective party to comply with formatting rules, e.g., converting to parent or child part numbers, prior to transmitting the information to a different party.

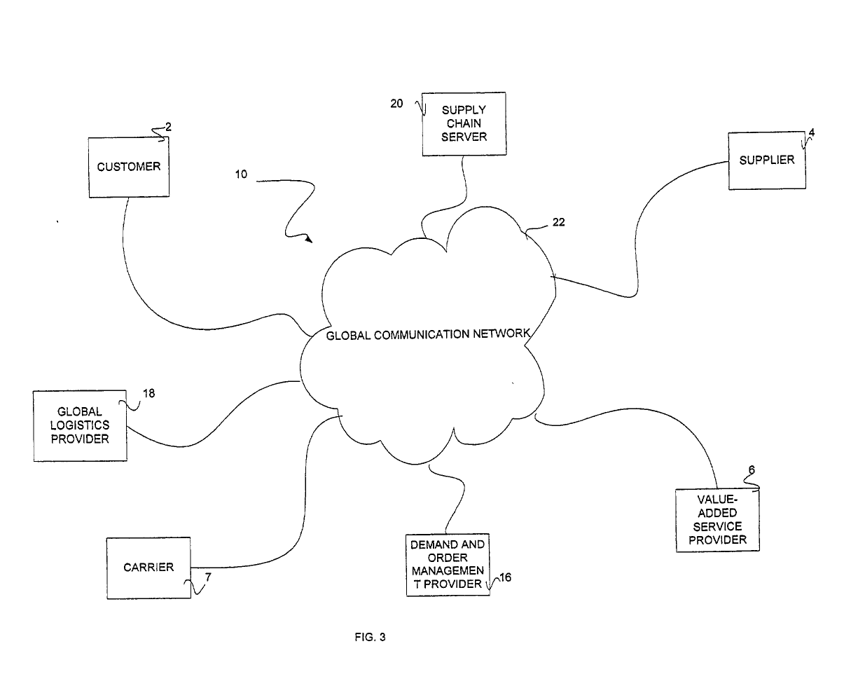

The present invention affords a relationship of parties that use a system and method of vendor managed inventory (“VMI”) processes. FIG. 3 shows an example arrangement of parties associated for implementing VMI processes in accordance with the present invention. As shown in FIG. 3, a customer 2, supplier 4, value-added service provider 6, carrier 7, demand and order management provider 16, global logistics provider 18 and supply chain server 20 are positioned to communicate and interact via global communication network 22. Preferably, one or more combinations of the parties identified in FIG. 3 interact to implement the processes described herein. All of the parties interact as directed by the supply chain server 20 and/or the demand and order management provider 16.

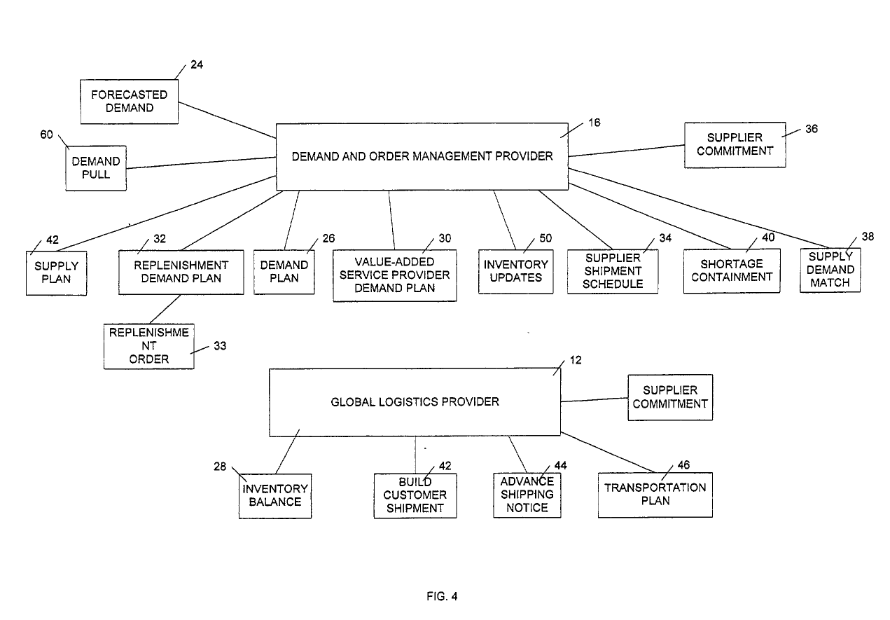

FIG. 4 shows elements that are generated, received and/or transmitted by and between the respective parties shown in FIG. 3 in accordance with the present invention. As shown in FIG. 4, the demand and order management provider 16 receives customer forecasted demands 24 that are generated by customers 2. The forecasted demands 24 identify components that customers will expect to require over a period of time. The demand and order management provider 16 preferably generates a demand plan 26 from the received forecasted demands 24, and the inventory data, specifically on-hand, WIP, and in transit inventory, received from the global logistics provider 18 and the value-added service provider 6.

The demand and order management provider 16 generates value-added demand plans 30 that include instructions for the value-added service provider 6. Further, the demand and order management provider 16 generates a replenishment demand plan 32 for restocking inventory to maintain safety stock levels while selling components to customers 2. The demand and management order provider 16 also generates and transmits a supplier shipment schedule 34 to identify a schedule for the suppliers 4. The demand and order management provider 16 preferably receives a supplier commitment 36 from suppliers 4 that identifies a commitment to supply components identified in the demand plan 26. The demand and order management provider 16 further performs a supply and demand match 38 that identifies whether there will be sufficient components to meet the demand identified in the demand plan 26. In the event that there is insufficient supply, then the demand and order management provider 16 further generates a shortage containment plan 40. Moreover, after the supply demand match 38 is performed, the demand and order management provider preferably transmits to the customer 2 a supply plan 42 identifying the components that will be delivered to the customer 2.

Also shown in FIG. 4, the global logistics provider 18 builds customer shipments 43 and generates advance shipping notice information 44 that identifies details directed to the shipment including, for example, ship dates, expected arrival dates, carriers, parts, quantities and the like.

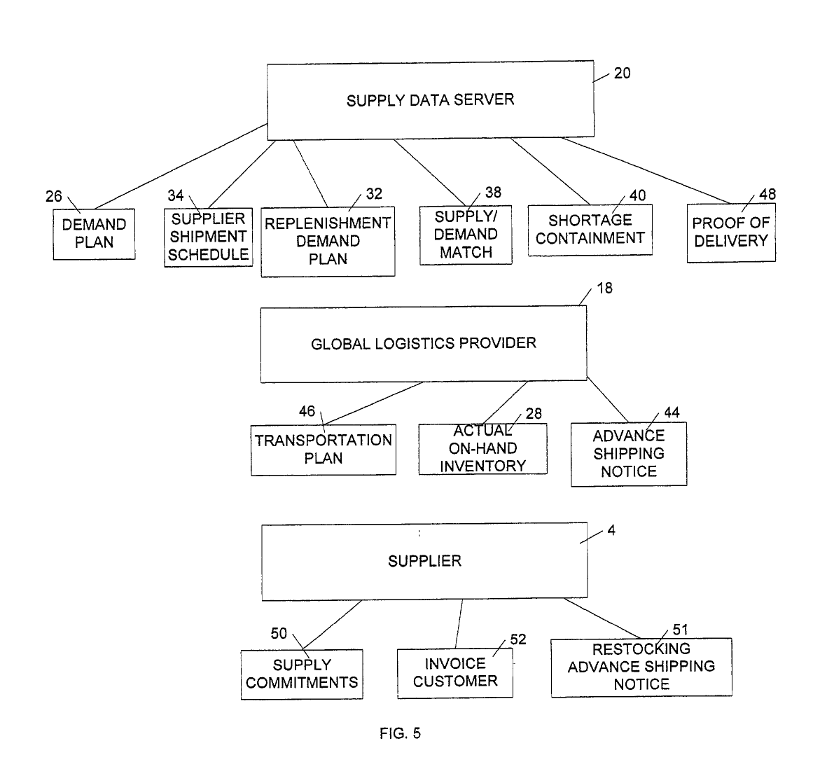

FIG. 5 shows elements that are created, received and/or transmitted by a supply chain server 20, logistics provider 18 and supplier 4 in accordance with an alternative embodiment of the present invention. As shown in FIG. 5, a supply chain server 20 calculates a demand plan 26 based upon received forecasted demands 24 from customers 2. The supply chain server 20 generates a replenishment demand plan 32 and a supplier shipment schedule 34 based on the calculated demand plan 26. The supply chain server further performs a supply/demand match 38, and, in the event a shortage is revealed therefrom, the supply chain server 20 invokes shortage containment rules 40 to handle such shortages. Moreover, the supply chain server 20 monitors delivery of the components to customers 2, and generates a proof of delivery 48 after a customer 2 identifies that a particular component has been received. Moreover, the supply chain server 20 preferably directs and closely monitors services performed by value-added service providers 6.

The global logistics provider 18 identifies actual on-hand inventory 28 and further generates advance shipping notice information 44 that is used by the supply chain server 20 to monitor delivery and receipt of components from suppliers 4. Moreover, as shown in FIG. 5, the supplier 4 receives daily inventory updates that identify the amount of VMI inventory 12 that is stored in VMI hub 11. Additionally, the supplier 4 preferably generates and transmits supply commitments 50, restocking advance supply notices 51, an invoice 52 to customers when a shipment advice is received from the supply chain server 20.

The demand and order management provider 16 and/or the supply chain server 20 is integral among the above-identified parties in fulfilling customer inventory demands. In addition to receiving forecasted demands 24, generating demand plans 26 and monitoring the eventual delivery of components to customers 2, the demand and order management provider 16 and/or the supply chain server 20 provides market intelligence, component management, data distribution and supply chain management. Other capabilities contributed by the demand and order management provider 16 include forecast analysis and rationalization, supply and demand matching and optimization, inventory analysis and management, proactive customer service, performance management and measurement, directing and coordinating of all the participants described herein. Additionally, professional services and improved VMI inventory visibility are provided by the demand and order management provider 16. This is provided, in part, by the demand and order management provider 16 and/or the supply chain server 20 transmitting and receiving electronic information, and archiving shipment history and VMI inventory tracking information that is accessible via a plurality of computer systems.

The global logistics provider 18 preferably) provides industry expertise and key capabilities to manage the physical VMI inventory 12 efficiently. For example, the global logistics provider 18 manages transportation, provides an information technologies infrastructure and increases confidence that customer demands will be fulfilled. Moreover, the global logistics provider 18 also provides industry expertise. Key capabilities of the global logistics provider 18 include a global logistics infrastructure of physical assets, logistics and efficient VMI warehouse and inventory management provided via VMI hub 11 operations. Also, the global logistics provider 18 improves visibility of the VMI inventory 12 both in a VMI hub 11 and in-transit, provides inventory ownership options and, when necessary, provides for postponement services.

The value-added service provider 6 also provides industry expertise and key capabilities for the system. As noted above, value-added services, include parts marking, programming, tape and reel and the like. The value-added service provider 6 also preferably provides for filly integrated digital circuit testing, provides full service programming centers (i.e., cross-docks 14) and also ensures visibility of a component's value-added process. Such visibility is implemented, for example, by publishing information on an Internet web site, automatically updating a party's internal computer systems, or by transmitting via e-mail, facsimile or telephone. Activities performed by the value-added service provider 6, as with third-party logistics provider 6, are preferably directed by the supply chain server 20 and/or the demand and order management provider 16.

Additionally, a value-added service demand plan 30 is generated by the demand and order management provider 16 for furnishing, for example, programming instructions and orders to value-added service providers 6. In a preferred embodiment of the present invention, the value-added service demand plan 30 is transmitted to the global logistics provider 18 and used to pick components, and transfer the components to a value-added service provider 6. The value-added service provider 6 preferably receives the picked components, and performs processes on the components, for example, programming the components directed in the value-added service demand plan 30. After performing value-added services, the value-added service provider 6 preferably transfers the value-added components to the global logistics provider 18, who receives the components and classifies them as available inventory.

In addition to fulfilling inventory needs for customers 2, the present invention provides for replenishment of VMI inventory 12. The demand and order management provider 16 preferably analyzes, reviews, validates, makes recommendations to suppliers 4 and, with supplier approval, periodically adjusts inventory targets. Unlike the inventory target setting and reviewing process, the replenishment process is executed on a regular basis as part of the standard cadence of operations. The demand and order management provider 16 preferably generates a replenishment demand plan 32 for generating replenishment orders that are transmitted to a supplier 4. The supplier 4 uses the replenishment and demand plan 32 to fulfill customer demands and to refill VMI inventory 11 levels, and further to generate advance shipping notice information 44. Advance shipping notice information 44 includes, for example, shipment information, including shipping and receiving dates, carrier 7 information, component parts quantities and the like.

The cooperation between the demand and order management provider 16, the global logistics provider 18, supply chain server 20 and/or the value-added service provider 6 ensures a results-oriented system and method for providing efficient VMI inventory management. All activities and interchanges are directed by the supply chain server 20 and/or the demand and order management provider 16. Thus, the vendor managed inventory processes, as described herein, provide extensive improvements over the prior art. More particularly, transaction costs are lowered, inventory levels and fulfillment cycles times are reduced, customer service is improved, risk is mitigated for buyers and sellers, and realization of revenue occurs earlier than the prior art inventory management.

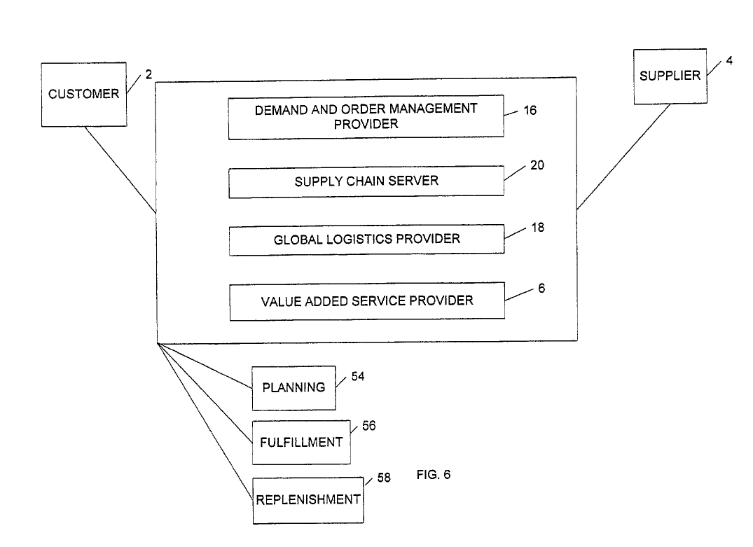

FIG. 6 illustrates an overview of VMI inventory processes in accordance with a first preferred embodiment of the present invention. As depicted in FIG. 6, suppliers 4, customers 2 and the supply chain server 20 utilize market intelligence and contribute to effective order and planning processes 54, fulfillment processes 56 and replenishment processes 58 for VMI inventory 12. The supply chain server 20, supplier 4 and customer 2 employ integrated systems, including a warehouse management system, value-added service system and a transportation management system to implement the processes and methods described herein.

Further, as shown in FIG. 6, three processes (i.e., planning, customer order and fulfillment, and replenishment) can occur both sequentially and simultaneously in accordance with the present invention. For example, a planning process occurs when demand forecasts 24 (FIG. 4) are received. Simultaneously, a replenishment process occurs that is directed to both prior customer fulfillment as well as maintenance of safety stock levels. The planning process comprises receiving forecasted demands 24 from customers 2 and commitments 36 (FIG. 4) from suppliers 4 as well as WIP and in-transit inventory from logistics providers and value added service providers. The demands 24 and commitments 36 eventually evolve into pull orders 60 from VMI hubs 11 associated with the customer order and fulfillment processes 56 associated with the present invention.

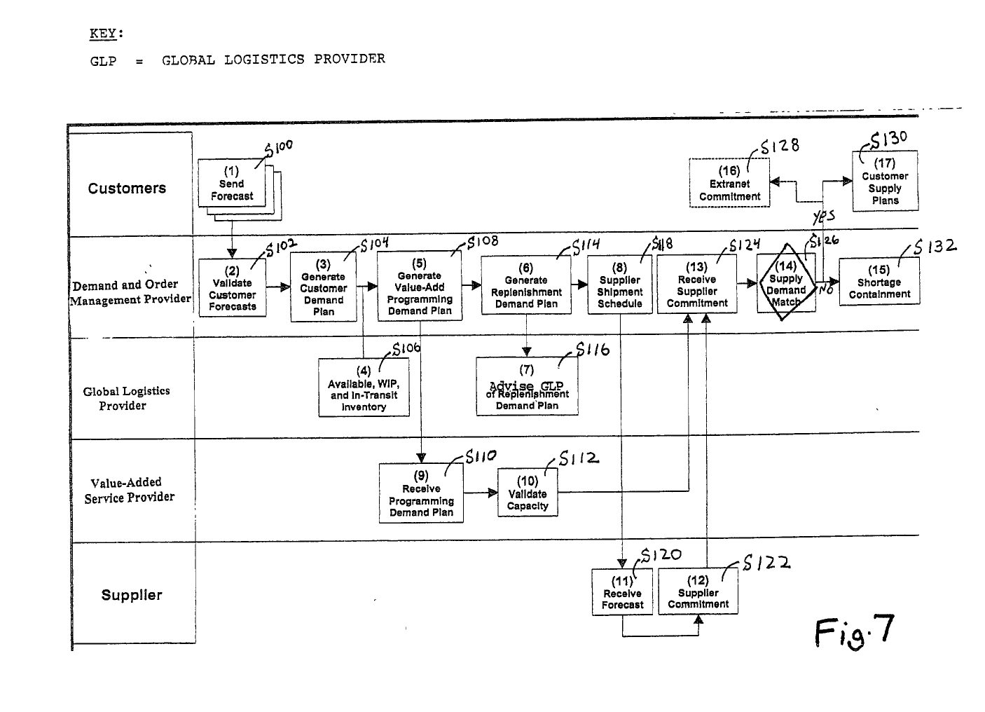

A description of the processes of the present invention in accordance with a preferred embodiment is discussed below, with reference to the flow charts in FIGS. 7-9.

FIG. 7 depicts details involved in the planning process 54 according to a first preferred embodiment of the present invention. At the outset of the planning process 54, customers 2 send a demand forecast 24 that is received by a demand and order management provider 16 (step S100). The demand and order management provider 16 receives the forecasted demands 24, and validates the demands, for example by comparing the forecasted demands with the customer's prior order history and/or contractual agreements between the customer 2 and supplier 4 (step S102). After the forecasted demand 24 is validated, the demand and order management provider 16 generates a customer demand plan 26 (step S104). The demand and order management provider 16 relies, in part, upon a transmission received from a global logistics provider 18 to generate the demand plan 26. The global logistics provider 18 determines available VMI inventory 12, for example, by assessing on-hand inventory, in-transit inventory and WIP inventory, and thereafter transmits its assessment to the demand and order management provider 16 (step S106).

After receiving the global logistics provider's VMI inventory status, the demand and order management provider 16 generates a value-added programming demand plan 30 (step S108). The demand plan comprises services, for example, programming services, to be performed on the available VMI inventory 12, by a value-added service provider 6. In step S110, the value-added service provider 6 receives the value-added programming demand plan 30 received from the demand and order management provider 16, and uses the demand plan 34 to validate its capacity to perform such value-added services (step S112).

The demand and order management provider 16 further generates a replenishment demand plan 32 which is transmitted to the global logistics provider 18 (step S114). The replenishment demand plan 32 estimates the amount of inventory that will be placed in a VMI hub 11 after the customer's forecasted demand 24 is met. In step S116, the demand and order management provider 16 advises the global logistics provider 18 of the replenishment demand plan 32.

The demand and order management provider 16 further generates a replenishment demand plan 26 for VMI hub 11 inventory maintenance as well as provides the supplier 4 with a customer forecast for revenue planning. In step S120, the supplier 4 receives the forecasted demand 24 from the demand and order management provider 16, and, in step S122, the supplier 4 generates a supply commitment 36 that is directed to the supplier's ability to meet customer demand and is transmitted back to the demand and order management provider 16. The demand and order management provider 16 receives the supplier commitment 36 (step S124), and thereafter preferably performs a supply and demand match 38 to determine whether the supplier commitment 36 matches the replenishment demand required to maintain inventory levels at the VMI hub 11 as well as support immediate customer demand (step S126). The results of the comparison in step S126 are transmitted to the customer 2, preferably automatically updating to the customer's internal computers for example, by updating as an extranet (step S128), and supply plans are received by the customer 2 (step S130). Moreover, the demand and order management provider 16 provides for shortage containment 40 in the event that a supply/demand match 38 reveals insufficient VMI inventory 12 to meet the customer's forecasted demands 24 (step S132).

In accordance with a first preferred embodiment of the present invention, the demand and order management provider 16 handles shortages regularly, for example on a weekly basis. Shortages occur when demand is greater than supply in a given period. To handle shortages, the demand and order management provider 16 determines, for example, whether a customer 2 is willing to receive the component(s) at a later date, or, alternatively, if the customer 2 would be willing to receive an alternative part. Alternative suppliers 4 may be queried to determine if substitute components are available.

Thus, in accordance with a first preferred embodiment of the present invention, the planning process 54 is implemented.

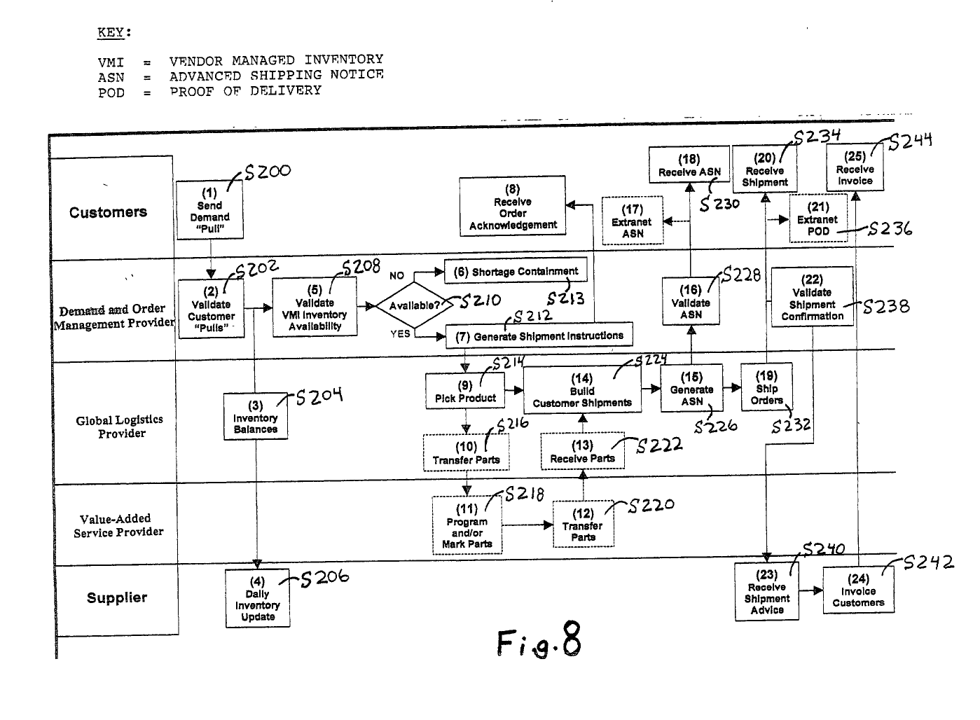

Referring now to the flowchart depicted in FIG. 8, processes associated with ordering and fulfillment 56 are discussed below with regard to a first preferred embodiment of the present invention.

At the beginning of the order and fulfillment process 56, a customer 2 sends a demand pull 60 (FIG. 5) to the demand and order management provider 16 (step S200). In step S202, the demand and order management provider 16 receives the customer pull 60. To assist with determining VMI inventory 12 availability, the demand and order management provider 16 receives, from the global logistics provider 18, inventory balances 28 (step S204). The global logistics provider 18 also transmits the inventory balances 28 to suppliers 4 for updating their periodic (e.g., daily, weekly, monthly, quarterly and the like) inventory updates (step S206). After receiving the VMI inventory balances 28 from the global logistics provider 18, the demand and order management provider 16 validates the VMI inventory 12 for availability (step S208).

In step S210, the demand and order management provider 16 makes a determination whether there is available VMI inventory 14 to satisfy the customer demand pull 60. If there is available VMI inventory 12, then, in step S212, the demand and order management provider 16 generates a shipment instructions 34 for global logistics providers 18. In the event that there is not available VMI inventory 12, then, in step S213, the demand and order management provider 16 performs shortage containment processes 40, as described above.

Continuing with the processes associated with fulfilling forecasted demands 24, the shipping schedule 34 are received by the global logistics provider 18 who picks the specific components from the VMI hub 11 (step S214). The global logistics provider 18, in step S216, transfers the components to the value-added service provider 6, who uses a value-added service demand plan 30 to service the components accordingly (step S218). Thereafter, the value-added service provider 6 transfers value-added components to the global logistics provider 18 (step S220). The global logistics provider 18 receives the value-added components (step S222), and aggregates components by customer in order to build customer shipments (step S224).

The global logistics provider 18 further generates advance shipping notice information 44, and transmits the advance shipping notice information to the demand and order management provider 16 (step S226). The demand and order management provider 16 validates the advance shipping notice information 44 (step S228), and, thereafter, transmits the advance shipping notice information to the customer 2. In a first embodiment of the present invention, the customer's internal computer system, for example, a private extranet, is automatically updated by the demand and order management provider 16 (step S230).

Moreover, the global logistics provider 18 ships orders based upon the advance shipping notice information 44 (step S232). The customer 2 receives the shipped orders from the global logistics provider 18 (step S234), and the customer 2 receives a proof of delivery (“POD”) 48 (step S236). While the orders are shipped from the global logistics provider 18 to the customer 2, the demand and order management provider 16 preferably confirms the shipment was sent (step S238) and all relevant data is correct, and transmits a confirmation to the customer 2. The supplier 4 receives shipment advice from the demand and order management provider 16 (step S242). Further, the supplier 4 generates a customer invoice and transmits the invoice to the customer 2 (step S244), who receives the invoice for tendering payment (step S242).

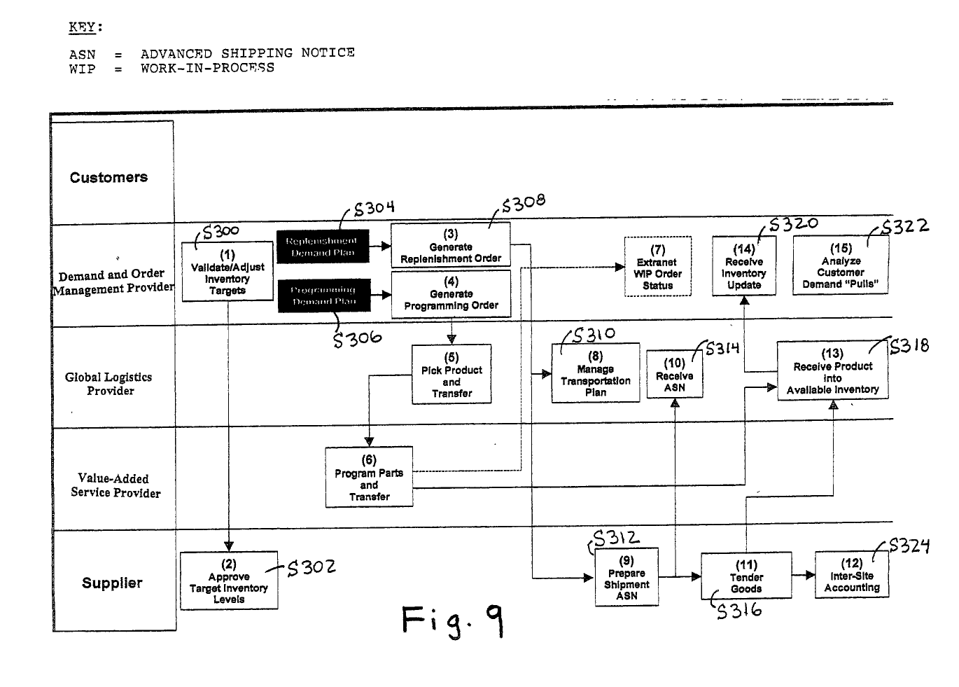

Referring now to the flowchart depicted in FIG. 9, processes associated with component replenishment 58 are discussed below, with regard to a first preferred embodiment of the present invention. The replenishment process 58 is preferably directed to demand and order management providers 16, global logistics providers 18, value-added service providers 6 and suppliers 4.

Periodically, as part of the replenishment process, the demand and order management provider 16 validates and/or adjusts inventory target levels (step S300). The demand and order management provider 16 preferably analyzes, reviews, validates, makes recommendations to suppliers and, with supplier 4 approval, adjusts inventory targets on a periodic basis. The demand and order management provider 16 further transmits validated inventory targets to a supplier 4, who confirms the targeted inventory levels (step S302).

After validating and/or adjusting the inventory target levels, the demand and order management provider 16 determines whether replenishment of inventory is indicated (step S304). If so, then the demand and order management provider 16 preferably generates a replenishment demand plan 32. Moreover, a value-added service demand plan 30 is developed by the demand and order management provider 16 after inventory targets for value-added parts have been validated and/or adjusted (step S306).

After generating the replenishment demand plan 32 (step S304), and receiving a supply commitment back from the supplier, the demand and order management provider 16 generates a replenishment order 33 (step S308) that is transmitted and received by the supplier 4. The replenishment demand plan 32 is transmitted to the global logistics provider 18 and is used to generate and manage a transportation plan 46 (step S310). The supplier 4 uses the replenishment demand plan 32 generated by the demand and order management provider 16 to prepare shipment of the component(s), and further to generate advance shipping notice information 44 (step S312). The supplier 4 then transmits the advance shipping notice information 44 to the global logistics provider 18 (step S314). The supplier 4 further tenders the component to the global logistics provider 18 after preparing the shipment (step S316).

The global logistics provider 18 receives the components into the VMI hub 11 and the components become part of the available VMI inventory 12 for planning 54 and fulfillment 56 (step S318). The demand and order management provider 16 further receives an inventory update that is generated by the global logistics provider 18 in step S320, and further analyzes future customer demand pulls 60 in light of the received inventory updates (step S322). Additionally, the supplier 4, after tendering the goods in step S316, performs accounting in order to be remunerated for the tendered goods (step S324). Thus, in accordance with a first preferred embodiment of the present invention, a replenishment process 58 for vendor managed inventory is completed.

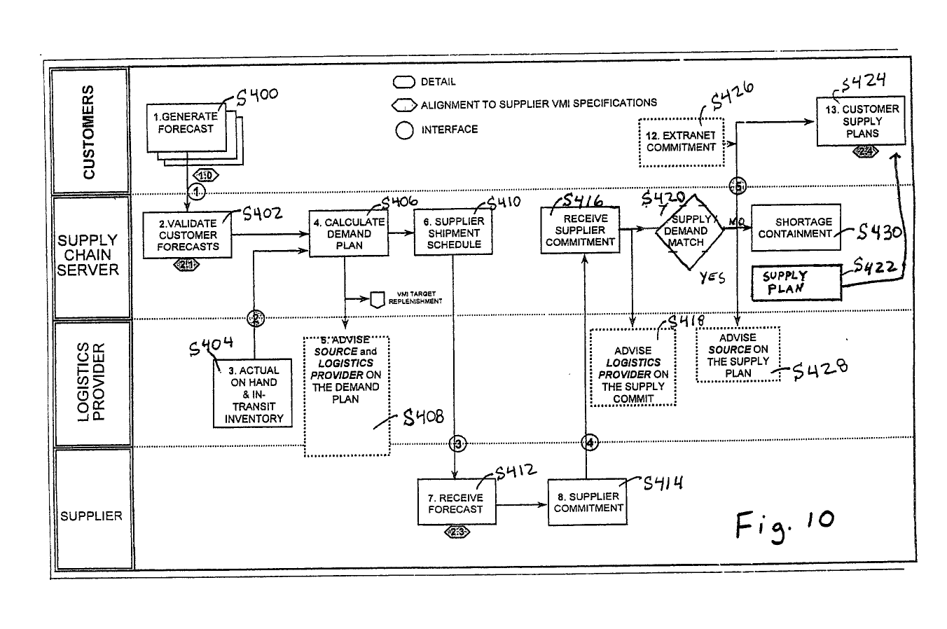

A description of the processes of the present invention in accordance with a second preferred embodiment is discussed below, with reference to the flow charts reference to FIGS. 10-12. The second preferred embodiment of the present invention, as described by way of example herein, has particular focus on automating processes for managing and monitoring activity of the value-added service provider 6.

Processes associated with forecasting and planning processes 54 in accordance with a second preferred embodiment of the present invention are described below with reference to FIG. 10.

Customers 2 generate and transmit forecasted demands 24 for components to a supply chain server 20 (step S400). Forecasted demands 24 preferably comprise thirteen week periods. Forecasted demands 24 are received and validated by the supply chain server 20, for example, by comparing the forecasted demands with the customer's 2 prior order history and/or contractual agreements between the customer 2 and a supplier 4 (step S402). Further, a global logistics provider 18 determines available VMI inventory 12, for example, by assessing on-hand inventory, in-transit inventory and WIP inventory, and transmits its assessment to the supply chain server 20 (step S404).

In part by using the assessment received from the global logistics provider 18, the supply chain server 20 calculates a demand plan 26 (step S406). The supply chain server 20 transmits the demand plan 26 to the global logistics provider 18 (step S408). In step S410, the supply chain server 20 generates a supplier shipment schedule 34 based upon the calculated demand plan 26, and transmits the supplier shipment schedule 34 to the supplier 4.

The supplier 4 receives the forecasted demands 24 and generates a supplier commitment 36 to supply the components identified in the demand plan 26 (step S412), and thereafter transmits the supplier commitment to the supply chain server 20 (step S414). The supply chain server 20 receives the supplier commitment 36 (step S416), and preferably transmits the supplier commitment 36 to the global logistics provider 18 (step S418). The supply chain server 20 further performs a supply and demand match 38 to determine whether the supplier commitment 36 matches the customer demand forecast 24 (step S420). If the results of the comparison indicate sufficient supply, then, in step S422 a supply plan 42 is generated by the supply chain server 20. The supply plan 42 is, thereafter, transmitted to the customer 2 (step S424), and is preferably uploaded to the customer's internal computer system, for example, a private extranet (step S426). Preferably, the global logistics provider 18 is also advised as to the supply plan 42 (step S428). In the even the supply chain server 20 determines that the results of the supply/demand match 38 in step S420 will not yield sufficient supply, then shortage containment processes 40 are implemented (step S430).

Additional details directed to the processes and corresponding steps described above, with respect to the forecast and planning processes 54, are described below.

The present invention preferably employs a supply cadence, wherein a customer 2 submits forecasted demands 24, preferably on a weekly basis, by an established cut-off time. Any forecasted demands 24 received after the established cut-off time are preferably evaluated during the following week. In a preferred embodiment, the use of electronic data interface, XML or other data mechanism is provided. However, customer forecast 24 can be submitted in various other formats, including e-mail, faxes, physical letters or telephone calls.

With regard to validating customer forecasted demands 24, the supply chain server 20 preferably verifies part numbers, quantities, and contractual obligations. Further, the supply chain server 20 preferably monitors forecasted demands 24 with pull history and trends, and identifies inconsistencies over time periods. Furthermore, supply chain server 20 contacts customers 2 with forecast anomalies and requests confirmation. In this way, customers 2 are given an opportunity to modify, approve or cancel forecasted demands 24 that are inconsistent with respect to prior ordering.

With regard to identifying actual on-hand and in-transit inventory, the global logistics provider 18 reviews available VMI inventory 12 levels in a VMI hub 11, and also VMI inventory 12 that is in-transit to the vendor managed inventory from the supplier's 4 origin warehouse, for example, in a foreign country. Additionally, a quantity of inventory is submitted in a demand plan 26 that represents the net of any WIP orders.

The supply chain server 20 preferably calculates demand plans 26 by translating customer forecasted demands 24 to parent level part numbers, and also by consolidating forecasted demands 24 for all customers 2. The demand plan 26 preferably includes actual on-hand inventory, and calculated target levels based upon in-transit and work in process orders. Further, the demand plans 26 preferably includes information directed to the time required for transit (e.g., a foreign country to the vendor managed inventory warehouse) and value-added services.

Further, the supplier 4 advises the value-added service provider 6 and global logistics provider 18 of the demand plan 26. The supplier 4 sends the demand plan 26, including the planned customer shipments, by child (and, optionally, parent) part number to the value-added service provider 6, and also to the global logistics provider 18 to facilitate capacity planning as needed.

The supply chain server 20 receives the supplier commitment 36 in an electronic format (e.g., EDI, XML or flat file), and loads the supplier commitment 36 into an application, for example, a database, and performs validation, ID exceptions such as quantity exceptions, part number exceptions, and incomplete responses. The supply chain server 20 further receives notifications from value-added service providers 6 directed to capacity constraints. A supply and demand match is generated that highlights shortages of both components as well as shortages due to value-add service provider capacity constraints. Specific business rules for shortage resolution vary by supplier but follow the general process of the supply chain service provider notifying the supplier of the shortage, supplier using their specific internal business rules to attempt to resolve it, supplier notifying the supply chain service provider of available product, supply chain server directing it out to EMS and customers.

In the event of a shortage, the supply chain server 20 will preferably notify the customer 2, global logistics provider 18, value-added service provider, 6 and supplier 4 of the shortage. The supply chain server 20 will preferably execute each supplier's specific shortage containment rules. Each supplier 4 may transmit details directed to managing shortages during an initial registration process with the supply chain server 20. Moreover, the supply chain server 20 may use a “fair-share” allocation as a default in the event of a short supply in customer supply plans. In such an event, all demanding customers 2 may receive an equal amount of the constrained supply, or the demanding customers 2 may receive a pro rata share of the constrained supply based upon how many components a particular customer 2 requested in relation to how many components other customers 2 requested. Further, the supply chain server 20 preferably confirms and resolves any value-added service provider 6 capacity issues that may exist.

In a preferred embodiment of the present invention, the supply chain server 20 posts a supplier commitment 36 or customer's and supplier's internal computer systems, for example, private extranets. The customer 2 and supplier 4 can see aggregate demand versus supply and can review the information to analyze individual customer demand.

Further, the customers 2 receive supply confirmation of their demand forecasted demands 24 from the supply chain server 20. Also, the supply plans 42 are transmitted to the customer 2 in formats defined by the customer 2, for example, electronic data exchange/flat file preferred, by e-mail, fax or telephone calls.

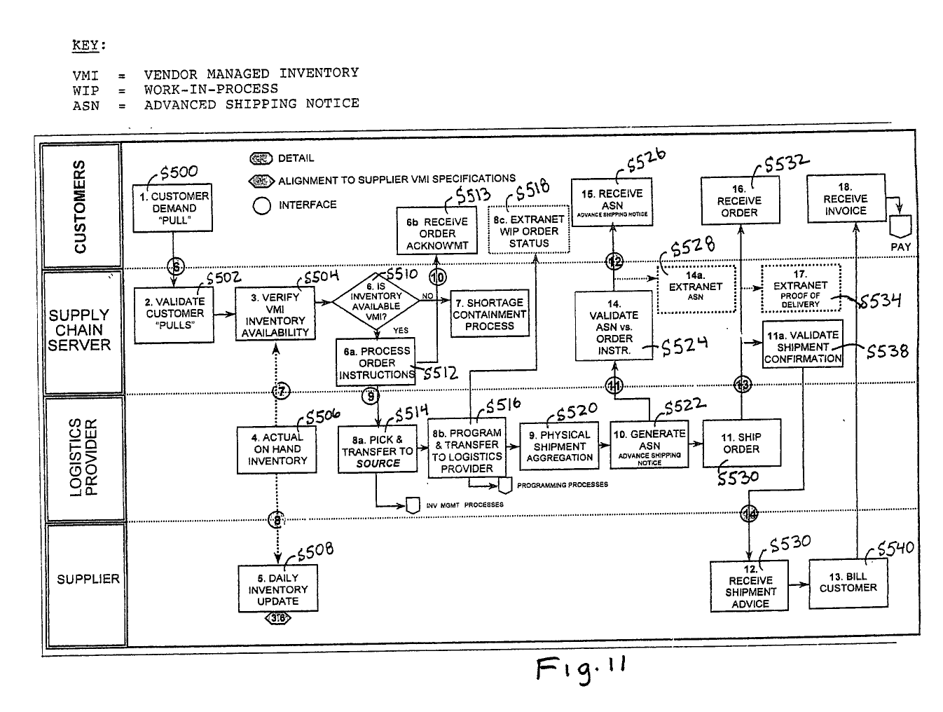

The processes associated with the order management and fulfillment process 56 are discussed below with reference to the flow chart in FIG. 11.

After customers 2 prepare and transmit forecast demand pulls 60 (step S500), the supply chain server 20 receives and validates customer pulls 60 (step S502). As used herein, a customer pull 60 refers to VMI inventory 12 required to be pulled from the VMI hub 11 to meet the customer's forecasted demand 24. In step S504, the supply chain server 20 verifies the available VMI inventory 12, for example, by analyzing actual on-hand inventory updates that are transmitted from the global logistics provider 18 (step S506). The global logistics provider 18 preferably transmits on-hand inventory information to suppliers 4 to provide the suppliers with a daily inventory update 50 (step S508).

After the supply chain server 20 verifies that there is VMI inventory 12 available in the VMI hub 11 (step S510), the supply chain server 20 processes instructions contained in the demand pull 60 (step S512). Upon processing instructions, the supply chain server 20 preferably updates the customer's internal computer systems to provide an acknowledgement (step S513).

The supply chain server 20 preferably transmits the processed order instructions to the global logistics provider 18 who picks the components from the VMI hub 11, and, if directed, the global logistics provider 18 further transfers the components to a value-added service provider 6 for providing value-added services (step S514). The value-added service provider 6, in step S516, performs value-added services on the respective components, and, thereafter, transfers the components back to the global logistics provider 18 (step S516). Moreover, the global logistics provider 18 preferably updates the customer's internal computer systems to inform the customer 2 that the components are effectively WIP (step S518). In this way, customers' 6 databases are regularly maintained.

In step S520, the global logistics provider 18 further performs physical shipment aggregation, and, in step S522, generates advance shipping notice information 44 and transmits the advance shipping notice information to the supply chain server 20. The supply chain server 20 receives the advance shipping notice information 44, and further validates the advance shipping notice information by comparing it with order instructions initially generated by the customer 2 (step S524). The supply chain server 20 thereafter transmits the advance shipping notice information 44 to the customer 2 (step S526), and the supply chain server further archives with the advance shipping notice information 44 (step S528).

In step S530, the global logistics provider 18 ships the order, and, in step S532, the customer 2 receives the order. The supply chain server 20 also receives information directed to proof of delivery 48 (step S534), and proceeds to validate the shipment confirmation and transmit the validated shipment confirmation to the supplier 4 (step S536). The supplier 4 receives shipment advice (step S538), and generates and transmits an invoice 52 to the customer 2 (step S540). The customer 2 is invoiced directly from the supplier 4 via a transmission from the supplier 4 to the customer 2 (step S542), and the customer 2 accordingly pays, preferably via electronic funds transfer (step S544). Thus the processes associated with managing and fulfilling orders are complete.

Additional details directed to the processes and corresponding steps described above, with respect to the order management and fulfillment processes 56, are described below in greater detail.

A customer demand pull 60 is treated by the supply chain server 20 as a discrete purchase order, and includes child level part numbers. Customer demand pulls can be placed daily, as customers 2 require a product. The demand pulls are preferably in an electronic format (e.g., EDI, XML or flat file), but other formats are accepted, such as e-mail and facsimile. After the customers 2 have generated demand pulls 60, the supply chain server 20 receives and validates the pulls. The supply chain server 20 validates specific fields in the purchase order, such as part numbers and component quantities, and compares these fields with corresponding records in suppliers' 4 databases. Thereafter, the supply chain server 20 verifies that VMI inventory 12 is available. Preferably, the supply chain server 20 consolidates demands by customer part numbers and ship-to addresses when VMI inventory 12 ships less frequency then the demand pulls 60 are received. For example, if the VMI inventory 12 ships twice weekly and customer's 6 demand pulls are received three times weekly, then customer demands for the VMI inventory 12 are preferably consolidated.

Further, the supply chain server 20 compares quantities of components included in customer demand pulls 60 with any restrictions or limitations on customer ordering, for example, a predefined “cap” placed to limit customer demands. A customer cap may be necessary in the event that customer demands in forecasted demands 24 exceed available VMI inventory 12. In accordance with the present invention, customer caps are defined in inventory contracts between the supply chain server 20 and the customer 2. The supply chain server 20 further preferably translates demand pull quantities by translating child part number to parent part numbers, and further checks available VMI inventory 12 by parent part number. Prior to fulfilling customer demands, the supply chain server 20 compares demand for available VMI inventory 12 (referred to herein as “confirmed”) with value-added service provider 6 capacities. The supply chain server 20 ensures that inventory is available at the VMI hub 11, and further that the customer 2 has not already pulled more components than defined in a cap for any given period.

After the customer demand pulls 60 are verified and the inventory availability has been assessed, VMI inventory 14 balances are transmitted to a supplier's 4 enterprise resource planning database/financials database, preferably on a daily basis. Further, the global logistics provider 18 provides information directed to VMI inventory 12, and physical locations of current VMI inventory 12 to the supply chain server 20. The supply chain server 20 receives information directed to available VMI inventory 12, i.e., the VMI inventory 12 minus the net of any WIP inventory and/or quarantined inventory (i.e., inventory that is discovered to be damaged or otherwise unavailable).

Preferably on a daily basis, the supplier 4 receives information to on-hand inventory, in addition to the WIP inventory and any quarantined inventory.

If VMI inventory 12 is available, then order instructions included with the customer pulls 60 are processed. The supply chain server 20 preferably transmits an acknowledgement, and/or order instructions to the global logistics provider 18 and to the value-added service provider 6. For example, the supply chain server 20 includes part numbers, quantities, ship dates and the like in the transmissions. The instructions are thereafter used to process additional order instructions. Moreover, the supply chain server 20 transmits order acknowledgements to customers 2, thereby informing customers 2 that their orders have been received and are being processed.

A shortage containment process is invoked which provides for demand that exceeds a customer cap and/or available inventory. Depending on a variety of factors, including, for example, suppliers' shortage containment processes, the specific VMI inventory 12 in question, the customers 2 demanding the VMI inventory 12, and registration information received by the supply chain server 20 directed to suppliers 4, global logistics providers 18 and customers 2, the supply chain server 20 determines appropriate business processes to handle the shortage. Shortage containment processes include processes to handle outside processor capacity constraints, and include implementing allocation rules as directed by suppliers 4.

After the global logistics provider 18 receives an order acknowledgement and/or instructions from the supply chain server 20, the global logistics provider 18 preferably performs specific tasks. For example, the global logistics provider 18 picks components from the VMI hub 11 in accordance with the order instructions. In a preferred embodiment, the global logistics provider 18 references parent part numbers to pick the components. After the global logistics provider 18 picks the components, it transfers parts to the value-added service provider 6 and changes the inventory status from available to WIP. When required, the value-added service provider 6 performs value-added services, for example, programming the parts in accordance with the order instructions received from the supply chain server 20. Other value-added services performed by the value-added service provider 6 include packaging and assembly. After picking and servicing the parts, the value-added service provider 6 transfers the parts to the global logistics provider 18 and changes the status of the inventory from WIP to finished. The customer 2 is informed preferably by electronic transmission, by the value-added service provider 6 that the components are being supplied and their respective status.

After the global logistics provider 18 receives the components from the value-added service provider 6, the global logistics provider 18 consolidates and packages the components for eventual shipment to the customer 2. In order to expedite delivery, the global logistics provider 18 secures carriers 17 and prepares shipment documentation, (e.g., commercial invoices, customs, documentations and the like).

The supply chain server 20 receives advance shipping notice information 44 from the global logistics provider 18 after the global logistics provider has prepared and shipped the product. The supply chain server 20 preferably validates the advance shipping notice information 44 by comparing the information with the customer demand pulls 60. The supply chain server 20 resolves any exceptions, for example, short ships, and also provides identifiers for the validated advance shipping notice information 44. Any exceptions that are identified are resolved by the supply chain server 20. Errors can include data errors or actual physical shipment errors. The supply chain server 20 works with the global logistics provider 18 to ensure errors are resolved prior to the customer 2 receiving the component(s) at a receiving location. Further, the customer's 2 internal computer systems receive the advance shipping notice information 44, thereby enabling the customer 2 to track the components. Alternatively, if no electronic advance shipping notice information 44 is required, then the advance shipping notice information 44 is available via a tracking system provided by the global logistics provider.

At this stage in the process, the supplier 4 ships the parts via the services agreed upon in contractual arrangements between customers 2, and global logistics providers 18. In a preferred embodiment, the global logistics provider 18 updates information directed to the VMI inventory, and changes the status of the VMI inventory 12 from finished to relieved. Moreover, suppliers 4 support specific requests directed to shipments, such as expediting an order, at an additional cost. Preferably, the customer 2 assumes responsibilities for the components, such as managing custom clearances, and the global logistics provider 18 provides corresponding documentation. Further, the global logistics provider 18 transmits shipment confirmations to the supply chain server 20, and the confirmations are stored for future use.

Once the supply chain server 20 receives shipping confirmations, it validates the shipping confirmations with the original order instructions. For example, the supply chain server 20 compares the components identifiers and resolves any exceptions, for example, short shipments. Further, the supply chain server 20 provides shipment advice 47 to suppliers 4, for example, for invoicing purposes. The supplier 4 confirms a sale based upon shipping advice 47 from the supply chain server 20, and the supplier 4 further invoices customer 2 for sale.

Thereafter, the customer 2 physically receives the order, including shipping documentation (e.g., a commercial invoice and packing slip), customer part number and purchase order numbers. The customer's 2 internal computer system 5 preferably receive the tracking information directed to purchases. Further, the customer 2 preferably receives invoices from the supplier 4.

A description of processes associated with entering information in supply chain server 20 is provided below.

In a preferred embodiment of the present invention, the supply chain server 20 receives information regarding VMI hubs 11, suppliers 4, customers 2 and VMI inventory 12. With respect to VMI hubs 11, suppliers 4 and customers 2, demographic information, such as commonly found in address book database applications, is entered into the supply chain server 20. When entering a new VMI hub 11, information regarding the VMI hub location, a business unit variable, for example, cross-dock or inventory hub, mailing information and the like.

When information regarding the new supplier 4 is entered into the supply chain server 20, information regarding the supplier's demographics is also preferably entered. Further, information regarding payment terms, for example, currency, whether to hold payment and bank account information, is also preferably submitted. Further, contact names and telephone numbers, e-mail addresses and the like are provided for the supplier 4. Other user-defined codes can be provided to enter information regarding suppliers 4 to provide any custom information regarding the supplier 4.

When information regarding a new customer 2 is entered into the supply chain server 20, as with VMI hubs 11 and suppliers 4, demographic information regarding the customer 2 is preferably entered into the supply chain server 20. Moreover, invoice information including, for example, payment terms, payment instructions, balances, currency codes and the like are provided. Additionally, collection information, for example, policy names, parties to send statements to, statement cycles, numbers of reminders to send to customers to collection reports and delinquency notices are preferably provided in the supply chain server 20. Also, billing information, such as associated customer price groups, whether back-orders are allowed, substitute orders are allowed, partial shipments are allowed, partial order shipments are allowed and the like are preferably provided in the supply chain server 20. Further, contact names, titles, remarks are provided for customers 2.

New VMI inventory 12 items are preferably approved and documented prior to being entered in the supply chain server 20. In a preferred embodiment of the present invention, an item parent record is created to identify and process each VMI inventory item in the supply chain server 20. The VMI item is preferably assigned to a VMI hub 11, and a supplier identifying record with, preferably, up to five related customer cross-reference item records identifying customer part numbers. Preferably, the item record has a unit of measure conversion associated therewith. Items are further classified in groups or inventory commitments. Thereafter, an output report is preferably generated that identifies successful data entry.

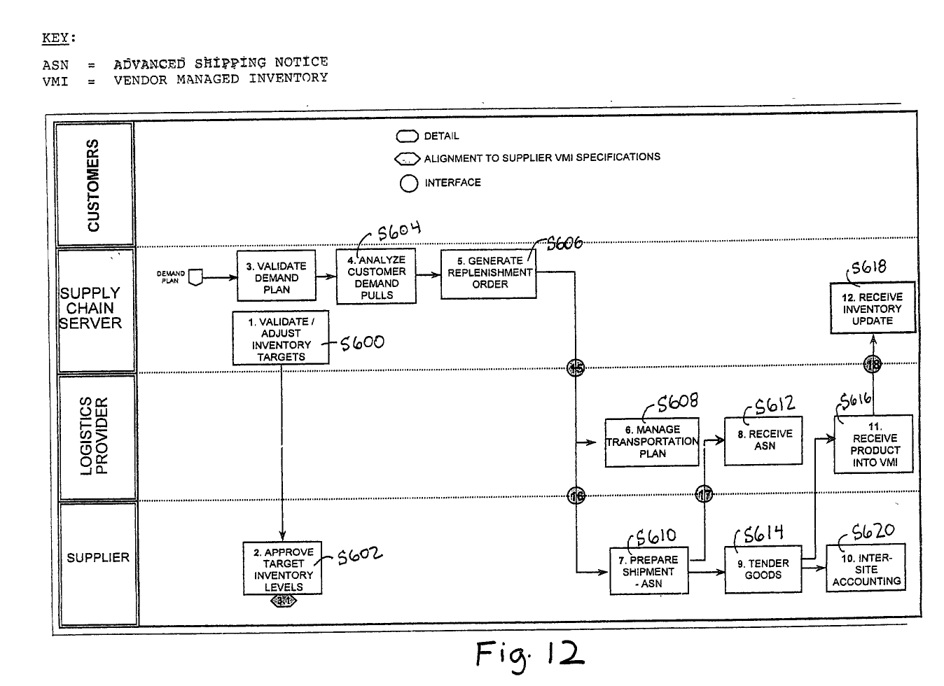

A description of the processes associated with replenishing 58 VMI inventory in accordance with the second preferred embodiment is provided below with reference to FIG. 12.

In order to replenish VMI inventory stock levels, the supply chain server 20 validates and, if necessary, adjusts inventory targets (step S600). The supply chain server 20 transmits the inventory targets to suppliers 4 for approval of the target inventory levels (step S602). Moreover, the supply chain server 20 uses a validated demand plan 26 (described above) to analyze customer demand in order to generate replenishment demand plans 32 (step S604) that include sufficient product to meet customer demands while maintaining inventory safety stock levels.

Once a replenishment demand plan 32 has been generated (step S606), the supply chain server 20 transmits the replenishment demand plan 32 to the global logistics provider 18 and to the suppliers 4 for either managing the transportation plan 46 (step S608) or to prepare a shipment or advance shipping notice information 44 (step S610). Suppliers 4 preferably transmit advance shipping notice information 44 directed to the replenishment demand plan 32 to the global logistics provider 18 (step S612). Additionally, the supplier 4 tenders goods (step S614), and forwards the components (or goods) to the VMI hub 11.

The global logistics provider 18 preferably receives the components into the VMI hub 11 (step S616), and transmits inventory updates to the supply chain server 20 (step S618). Additionally, the suppliers 4 perform accounting, based on the tendered goods (step S620).

Additional details directed to the processes and corresponding steps described above, with respect to the replenishment processes 58, are described below in greater detail.

As noted above, the supply chain server 20 performs periodic (e.g., monthly) review of inventory targets and compares the levels with customer forecasted demands 24 and actual order histories to identify risk areas and potential opportunities to reduce inventory levels. The supply chain server 20 preferably recommends inventory target levels based on forecasted demands 24, current usages, and target service levels. The supply chain server 20 may receive instructions from suppliers 4 and adjust the total inventory calculations in response thereto. The supply chain server 20 further transmits the validated and adjusted targeted inventories to suppliers 4, who review and approve the recommended changes to the inventory target calculations. Preferably, the supplier 4 maintains financial responsibility, including buy-off responsibilities for the VMI inverter 12. Further, the supply chain server 20 reviews any current period demand plans 26.

The supply chain server 20 monitors customer demand pulls 60 and inventory levels between replenishment cycles, in order to analyze customer demand pulls 60 and to identify replenishment requirements due to satisfied demand pulls 60 outside of expected demand cycles, for example, potential stock-outs. Thereafter, the supply chain server 20 sends a replenishment demand plan 32 to the global logistics provider 18 that uses the same cycle of time as used during forecast planning (e.g., weekly). In a preferred embodiment, the replenishment quantity is determined, in part, by the current demand plan 26, and is identified by the current component part number. The replenishment quantity is preferably determined by a net of the customer demand, on-hand VMI inventory 12, any in-transit inventory from a warehouse (e.g., located in a foreign country), and from current target levels. Replenishment requirements are communicated by the supply chain server 20 to the supplier 4 and logistics provider 10 when they are identified.

After the global logistics provider 18 receives a replenishment demand plan 32, the global logistics provider 18 selects a carrier 17, in part, based on shipment volume and transportation service levels. In this way, the use of specific carriers 17 is optimized. Transportation planning is based on standard pick-up trends, for example, 10:00 a.m. after the replenishment demand plan 32 is transmitted, because advance shipping notice information 44 does not always provide sufficient transportation planning in the long term. Additionally, the specific transportation service levels (e.g., expediting protocols to be defined for exceptional cases, including unusual replenishment requirements) are agreed upon by the global logistics provider 18, supplier 4 and customer 2. Further, the global logistics provider 18 maintains a shipment tracking system databases. This shipment tracking system is used by the parties to determine advance shipping notices, and further to identify in-transit VMI inventory 14.

The supplier 4 sends advance shipping notice information 44 that preferably includes parent part numbers, quantities and shipment dates to the logistics provider. During a replenishment process, the supplier 4 sends an advance shipping notice to the global logistics provider 18, and ships the component via its preferred carrier (which may or may not be associated with the global logistics provider) to the VMI hub 11, where goods are tendered to the global logistics provider. The global logistics provider 18 receives the component and confirms whether or not the inventory that was expected per the advance shipping notice is what was actually received. The global logistics provider 18 receives the advance shipping notice information 44, and updates the supply chain server's tracking system, for example, by submitting order numbers, part numbers and quantities, and, further, expected receipt dates to the VMI hub 11.

While the components are being tendered, the supplier 4 performs system transactions to transfer the inventory, for example, an intra company transfer from an existing supplier owned physical warehouse to the VMI hub, which is owned by the global logistics provider, but where inventory stored there is owned by the supplier, hence it's a “virtual warehouse.” Thereafter, the product is received into the VMI hub 11 and the global logistics provider 18 validates the part numbers and quantities against the supplier's 4 advance shipping notice information 44. Any necessary exception processes, such as expediting shipment, are preferably implemented. The global logistics provider 18 preferably transmits information to the supply chain server 20. The information is directed to the available VMI inventory 12. Any exception processes necessary to manage the components, for example, those that may be damaged while in-transit are performed. As noted above, damaged inventory may be segregated and identified as “quarantined.”

Thereafter, the supply chain server 20 preferably receives inventory update files from the global logistics provider 18. For example, if the supply chain server 20 does not receive a confirmation, then such exceptions are identified. Further, the supply chain server 20 preferably compares shipment-related information and replenishment information in order to identify and update VMI inventory 12 levels. In this way, the supply chain server 20 maintains accurate records for managing VMI inventory 12.

A discussion directly to operation management processes of the present invention are now described. Features of operation management processes include customer service (e.g., responding to customer 2 inquiries, and managing exceptions), physical inventory management, physical warehouse security, product data maintenance, customer data maintenance, performance measurements, systems data quality assurances, operations capacity planning and management of technology interfaces.

As used herein, component-related data maintenance generally refers to a plurality of processes that are performed on electronic data directed to customer demand pulls 60 and VMI inventory 12. Specifically, the supply chain server 20 accommodates a plurality of database management operations, including, for example, adding new part numbers to a database, and changing existing part numbers. Other data maintenance operations include changes to trade compliant dates, price changes (e.g., for commercial invoices), and internal programming code changes.

In addition to product maintenance, the supply chain server 20 preferably performs customer data maintenance. For example, default transportation service levels are defined and entered by the supply chain server 20. In a preferred embodiment of the present invention, each customer 2 is identified with a particular level of transportation service that is provided for the respective customer's demand pull 60. The supply chain server 20 preferably accommodates changes to default transportation service levels. Other customer data maintenance tasks include identifying and directing packaging and labeling of components, identifying and implementing policies directed to product returns, and determining a customer's credit available.

In addition to product and customer data maintenance, the supply chain server 20 preferably determines performance measurements. Examples of performance measurement includes component fill rates and time required to deliver VMI inventory 12. Moreover, the supply chain server 20 measures the degree of accuracy of customer forecasted demands 24, accuracy of inventory levels, and also the degree of programming yields with respect to value-added service providers 6. Further, the supply chain server 20 preferably performs systems data quality assurance, including, for example, reconciling WIP inventory, scrap inventory, and existing orders. Moreover, the supply chain server 20 manages technology interfaces, and, if necessary, makes appropriate changes to customer 2 data formats and values.

By combining industry expertise, demand planning and order management, value added services, improved visibility and physical warehouse assets, the VMI processes, in accordance with the present invention, provide scalable, shared and global solutions that directly result in significant benefits. Profitability increases as a direct result of lowering transaction costs and reducing inventory levels and fulfillment cycle time. Additionally, risk is mitigated for both buyers and sellers, and customer service improves. Moreover, suppliers enjoy earlier recognition of revenue.

Industry expertise includes component data management, market intelligence, procurement services, commodity knowledge, transportation management information technologies, confidence in the marketplace and brand stability. Demand planning and order management 54 includes improved customer service, supply/demand optimization and inventory planning. Benefits that are realized by effective demand planning and order management include lower transactional costs, reductions in inventory levels and reduced fulfillment cycle times. Value-added services, include programming services, part marking, tape and reel processes, on-line first article processing, testing and reel labeling result in lowering overhead, lowering transactional costs, and reducing fulfillment cycle times.

Moreover, utilization of physical warehouse assets, including, for example, high-velocity logistics, VMI hubs 11, cross-docks 14, inventory aggregation, inventory ownership options and postponement services, effectively reduce the time typically required to fulfill customer demands, reduce inventory levels, and lower transactional costs. The processes of the present invention also provide significant visibility, including, for example, customer aggregated demand, supply commitment matches, on-hand inventory levels, in-process and in-transit information, advance shipping notice information and proof of delivery. Such visibility improvements over the prior art increase confidence in the market, improve customer service and lower transactional costs.

The relationship of the parties afforded by the present invention, including a global logistics provider 18, a value-added service provider 6 and a demand and order management provider 16 further ensures reduced costs and increased productivity.

Global logistics providers 18 provide industry expertise in global logistics, transportation management, information technologies infrastructures, deliver-to-promise confidence, and brand and financial stability. The capabilities provided by the global logistics provider 18

The present invention manages a plurality of services preferred during the operations management of the processes described above, i.e., the planning, the order and fulfillment and replenishment processes associated with vendor managed inventory.

Processes associated with operations management include maintaining product data and related information, providing customer data maintenance (e.g., formatting and converting data to comply with routine parameters, assuring systems data quality, and managing a plurality of technology interfaces). Additionally, operations management processes includes measuring performance, planning for capacity, afford cycle counting and physical inventory management, thereby ensuring that physical warehouses are secure. Moreover, value-added services, including programming parts and assemblage, are ensured via the management processes described herein.

In accordance with the present invention, a variety of activity-based costing is incurred. For example, forecast and planning costs, customer service and order management costs, and information technology and interface requirements incur costs. Accordingly, fee structures are implemented to enable the vendor managed inventory processes to occur. Global logistics providers 18 also incur warehouse operations and network management costs. Further, value-added service providers 6 incur costs directed to programming operations and a variety of product based costs.

The above-described benefits are made possible, for example, by implementing reduction in inventory sites, and increases in information visibility ensures. Further, sharing physical assets results in risk pooling for multiple customers and multiple customer usage locations. Although the present invention has been described in relation to particular embodiments thereof, many other variations and modifications and other uses will become apparent to those skilled in the art. Therefore, the present invention is not limited by the specific disclosure.

What is claimed is:

1. A system and for managing physical inventory and inventory-related information in a supply chain, said system comprising:
a demand and order management provider, said demand and management provider being adapted to receive at least one forecasted demand for at least one component from at least one customer, generate a demand plan in response to said at least one forecasted demand, and transmit said demand plan to at least one supplier;
a global logistics provider, said global logistics provider being adapted to manage storage, retrieval and transportation of said at least one component; and
a value-added service provider, said value-added service provider being adapted to perform services on said at least one component in accordance with said at least one forecasted demand, wherein said demand and order management provider is further adapted to direct said global logistics provider and said value-added service provider to ensure that said at least one component is deliverable to said at least one customer a method for warehousing co-mingled inventories that are not segregated by customer or EMS.

2. The system of claim 1, further comprising an inventory storage facility, wherein said at least one component is received from a plurality of suppliers and stored in said inventory storage facility.

3. The system of claim 2, wherein said demand and order management provider is further adapted to direct said global logistics provider to retrieve said at least one component stored in said inventory storage facility.

4. The system of claim 3, wherein said demand and management order provider is further adapted to direct said global logistics provider to transfer said at least one component to said value-added service provider, and to direct said value-added service provider to perform said services on said at least one component in accordance with said at least one forecasted demand.

5. The system of claim 4, wherein said services include at least one of programming, tape and reel services, packaging, parts marking and testing.

6. The system of claim 4, wherein said value-added service provider identifies said at least one component as at least one of a work in process, in transit, and quarantined.

7. The system of claim 1, wherein said global logistics provider is further adapted to transport said at least one component from one of said global logistics provider and said value-added service provider to said at least one customer.

8. The system of claim 1, wherein said demand and order management provider is further adapted to receive inventory levels information from said global logistics provider, said inventory levels information representing a quantity of said at least one component located in an inventory storage location,
to generate a replenishment plan in response to said inventory levels information, and
to transmit said replenishment plan to said at least one supplier.

9. The system of claim 8, wherein said at least one supplier supplies said at least one component in response to said replenishment plan to said global logistics provider, and said global logistics provider stores said at least one component in said inventory storage location.

10. The system of claim 8, wherein said demand and order provider is further adapted to adjust inventory target levels in said inventory storage location as a function of said inventory levels information.

11. The system of claim 1, wherein said global logistics provider is further adapted to provide an infrastructure to implement logistics directed to said at least one component.

12. A system for managing inventory in a supply chain, said system comprising:
a planning process module, said planning process module being adapted to receive a forecast of demands for components and generate at least one of a demand plan, value-added demand plan, and a replenishment demand plan;
an order and fulfillment process module, said order and fulfillment process module being adapted to receive a demand pull, retrieve a component from an inventory storage location, perform a value-added service on said component and deliver said component to at least one customer; and
a replenishment process module, said replenishment process module being adapted to validate inventory levels in said inventory storage facility and replace components in said inventory storage location.

13. The system of claim 12, wherein said planning process module is further adapted to validate said forecast of demands, and to prepare and transmit a demand plan identifying components included in said forecast of demands to a global logistics provider and a supplier. We don't understand this claim.

14. The system of claim 13, wherein said planning process module is further adapted to receive a commitment from said supplier in response to said demand plan, and to perform a comparison of said commitment with said demand plan to determine whether there is sufficient inventory to satisfy said forecast of demands and respond to customers.

15. The system of claim 14, wherein said planning process module is further adapted to implement shortage containment rules when said comparison reveals insufficient supply to meet demand.

16. The system of claim 15, wherein said shortage containment rules are directed by said supplier.

17. The system of claim 12, wherein said planning process module is further adapted to receive and analyze inventory information, wherein said inventory information is directed to at least one of available inventory, in-transit inventory, work in process inventory and quarantined inventory.

18. The system of claim 12, wherein said order and fulfillment process module is further adapted to perform at least one of:
receive and validate a pull for at least one component;
verify available inventory in said inventory storage location;
direct a global logistic provider to retrieve said available inventory from said inventory storage location;
direct said global logistics provider to transfer said at least one component to a value-added service provider;
direct said value-added service provider to perform value-added services on said at least one component; and
direct at least one of said global logistics provider and said value-added service provider to transfer said component to said at least one customer.

19. The system of claim 18, wherein said global logistics provider generates advance shipping information, said advance shipping information representing said component in transit and including at least one of shipping and receiving dates, carrier information, component quantities and component characteristics.

20. The system of claim 19, wherein said order and fulfillment process module is further adapted to provide information directed to said advance shipping information to said at customer and said supplier.

21. The system of claims 12, wherein said replenishment process module is further adapted to generate a replenishment demand plan after said inventory levels are validated and indicate a need for replenishment.

22. The system of claim 12, wherein said replenishment process module is further adapted to transmit said replenishment demand plan to a supplier, wherein said supplier receives said replenishment demand plan and tenders said at least one component as a function of said replenishment demand plan.

23. The system of claim 22, wherein said replenishment process module is further adapted to direct a global logistics provider to receive said at least one tendered component in an inventory storage location.

24. A system for inventory planning, said system comprising:
an inventory planning module, said inventory planning module receives at least one forecasted demand for at least one component from at least one customer;
a customer order and fulfillment module, said customer order and fulfillment module generates a demand plan for fulfilling said forecasted demands; and
an inventory replenishment module, said inventory replenishment module evaluating at least quantity of at least one component in an inventory storage location and generating a replenishment demand plan in response to said step of evaluating.

25. The system of claim 24, wherein said inventory planning module further validates said at least one received forecasted demand by comparing said at least one received forecasted demand from said at least one customer with a history of orders placed by said at least one customer.

26. The system of claim 24, wherein said customer order and fulfillment module further transmits said demand plan to a supplier of said at least one component.

27. The system of claim 24, wherein said supplier transmits a commitment to said customer order and fulfillment module, said commitment representing said supplier's intention to supply said at least one component to said customer.

28. The system of claim 27, wherein said customer order and fulfillment module further performs a comparison of said at least one forecasted demand with said commitment received from said supplier to determine whether said supplier can supply said at least one component to said customer.

29. The system of claim 28, wherein said customer order and fulfillment module further provides shortage containment when said comparison reveals said supplier cannot provide said at least one component to said customer.

30. The system of claim 29, wherein said shortage containment includes at least one providing said at least one component at a later date, locating and providing at least one alternative component, and locating an alternative supplier of said at least one component.

31. A system for managing processes associated with providing at least one component to at least one customer, said system comprising:
a supply chain server, said supply chain server receiving at least one demand pull from at least one customer for at least one component located in an inventory storage location;
at least one supplier, said at least one supplier providing said at least one component and storing said at least one component in said inventory storage location; and
a global logistics provider, said logistics provider retrieving said at least one component from said inventory storage location, and sending said at least one component to said at least one customer.

32. The system of claim 31, wherein said logistics provider transmits inventory levels information to said supply chain server, said inventory levels information representing components stored in said inventory storage location.

33. The system of claim 32, wherein said supply chain server uses said inventory levels information to generate replenishment demands, said replenishment demands representing a directive to said at least one supplier to supply at least one component for said inventory storage location.

34. The system of claim 31, wherein said supply chain receives at least one customer preference profile, said at least one customer preference profile representing a customer's preferences for at least one supplier and at least one component.

35. The system of claim 34, wherein said supply chain server cross references said at least one demand pull with said at least one customer preference profile.

36. The system of claim 35, wherein said at least one demand pull comprises child level part numbers, said child level part numbers representing components that include value-added services.

37. The system of claim 36, wherein said supply chain server further receives at least one forecasted demand for at least one component from said at least one customer, said at least one forecasted demand representing at least one component said at least one customer will order in the future.

38. The system of claim 37, wherein said supply chain server further transmits said at least one forecasted demand to said at least one supplier, and said at least one supplier transmits at least one commitment to fulfill said at least one forecasted demand.

39. The system of claim 38, wherein said supply chain server further compares said at least one commitment with at least one of said forecasted demands and inventory levels information received from said logistics provider, said inventory levels information representing components stored in said inventory storage location.

40. The system of claim 39, wherein said supply chain server uses said comparison to determine whether a shortage exists.

41. The system of claim 40, wherein said supply chain server provides for shortage containment when a shortage exists.

42. A method for managing inventory, said method comprising:
receiving forecasted demands for at least one component from at least one customer;
generating a demand plan in response to said forecasted demands;
transmitting said demand plan to at least one supplier;
receiving said at least one component from said supplier in an inventory storage location;
transporting said at least one component from said inventory storage location to a value-added service provider;
transporting said at least one component from said value-added service provider to said at least one customer; and
replenishing said inventory storage location with at least one other component from said supplier.

43. The method of claim 42, further comprising transport of said at least one component from an inventory storage site to said value-added service provider for performing services on said at least one component.

44. The method of claim 43, further comprising receiving value-added service information, said value-added service information representing the status of services performed on said at least one component.

45. The method of claim 44, wherein said value-added service information identifies said at least one component as a work in progress.

46. The method of claim 45, wherein said value-added service provider further authorizes said at least one component to be sent to said customer after performing said services on said at least one component.

47. The method of claim 46, further comprising transporting said at least one component from said value-added service provider to said at least one customer.

48. The method of claim 47, further comprising receiving component transport information, said component transport information representing the at least one component being in transport.

49. The method of claim 42, further comprising receiving inventory levels information, said inventory levels information representing a quantity of said at least component located at said inventory storage location, generating a replenishment plan in response to said inventory levels information, and transmitting said replenishment plan to said suppliers.

50. A system for managing inventory and inventory-related information in a supply chain, said system comprising a global logistics provider, said global logistics provider being adapted to manage storage, retrieval and transportation of said at least one component in at least one regional inventory hub, wherein said at least one regional inventory hub holds components received from a plurality of suppliers, and wherein said global logistics provider is adapted to transport said components to a plurality of customers.

51. The system of claim 50, wherein storage of said inventory is not directed to segregated by said plurality of customers and said plurality of suppliers.

52. The system of claim 50, wherein said inventory comprises at least one of on-hand inventory, work-in-process inventory, and in-transit inventory.

53. A method for managing inventory and inventory-related information in a supply chain, said method comprising:
order planning, said step of order planning comprising receiving, validating and analyzing order forecasts, a current location of said inventory, consumption of said inventory, in-transit inventory and work-in-process inventory;
order fulfilling, said step of order fulfilling comprising providing said inventory to at least one customer; and
order replenishing, said step of order replenishing comprising at least one analyzing and evaluating an amount of said inventory, said in-transit inventory and said work-in-process inventory.
